(19) United States
(12) Patent Application Publication
(10) Pub. No.: US 2012/0130937 A1
(43) Pub. Date: May 24, 2012

(54) SECURITY AT A FACILITY

(75) Inventors: David Leon, JR., Desert Hot Springs, CA (US); Armando Lopez, Coachella, CA (US); Gabriel Saenz, La Quinta, CA (US)

(73) Assignee: Twenty-Nine Palms Band of Mission Indians, Coachella, CA (US)

(21) Appl. No.: 13/297,184

(22) Filed: Nov. 15, 2011

Related U.S. Application Data
(60) Provisional application No. 61/415,128, filed on Nov. 18, 2010.
(60) Provisional application No. 61/503,859, filed on Jul. 1, 2011.

(51) Int. Cl. G06F 9/44; G06F 17/30

(52) U.S. Cl. 706/52; 707/769; 707/E17.014

(57) ABSTRACT

Techniques described in this paper are associated with improving security at a facility. A system constructed in accordance with the techniques can assist security personnel with preventing incidents (e.g., crime, disorder, nuisance, property loss) at a facility, especially one open to public visitation (e.g., amusement parks, casinos, shopping centers). Assisting security personnel in preventing incidents can include readily providing adequate and appropriate security and non-security related information to security personnel, whether the security personnel (e.g., security officer) is stationed in a security office or on patrol (i.e. in the field) at the facility.

### CROSS-REFERENCE TO RELATED APPLICATIONS

The present application claims priority from and the benefit of U.S. Provisional Patent Application No. 61/415,128 filed Nov. 18, 2010, and entitled “Clear 4 One Casino Crime Database System,” and U.S. Provisional Patent Application No. 61/503,859 filed Jul. 1, 2011, and entitled “Preventing Security Issues at a Facility,” each which is incorporated by reference herein.

### BACKGROUND

Traditionally, private facilities, especially those frequented by the public (e.g., amusement park, shopping center, casino), rely heavily on private security forces (also referred to herein as “security personnel”) to ensure order and safety amongst not only those working at the facility (e.g., employees, contractors) but also those merely visiting the facility. Usually, the larger the size of the facility, the larger the security force that is required to maintain order and security. Additionally, the nature of the facility often has a direct impact on the size of security force, the type of security force utilized (e.g., lethally or non-lethally armed security force), and the types of incidents encountered by the security force (e.g., theft, assault, battery, disorderly conduct).

In general, when security personnel (e.g., security guard, safety officer) are performing their duties, they patrol designated areas of the facility and look out for suspicious people or activities in those areas. At times, this can involve security personnel having to approach and question unknown individuals that may be in unauthorized areas of the facility or that may be suspected of performing a crime or offense at the facility (or elsewhere). Security personnel often approach such individuals with no prior knowledge of individual's identity, the individual's past incidents at the facility, or the individual's criminal background. Such information is usually only obtained by security personnel once they have questioned the individual, or once the individual has provided at least some form of identification (e.g. employee identification, drivers license, passport, etc.). This can lead to dangerous situations because security personnel first required to approach the individual before knowing whether the individual poses a danger to security personnel or others at the facility.

For example, from time to time, members of a casino security force (i.e., security officers) have to deal with casino patrons that are drunk and disorderly at the casino. The patron may be an individual who has been to the casino before and portrayed dangerous behavior (e.g., violence) during their past encounters with security personnel. On the other hand, the patron may be generally well-behaved individual but be an individual known to have cheated the casino in the past (e.g., casino scammer, user of counterfeit currency) or committed crimes in the area. Accordingly, facilities, especially those open to the public, would prefer their security forces to have the ability to identify troublesome individuals, generally before an incident occurs, before security personnel have to approach such individuals, and, sometimes, before such individuals even enter a facility. With such knowledge, a security force can at the very least keep watch over such individuals, if not deny them entry to the facility or remove them from the facility altogether.

### SUMMARY

Techniques described in this paper are associated with improving security at a facility. A system constructed in accordance with the techniques can assist security personnel with preventing incidents (e.g., crime, disorder, nuisance, property loss) at a facility, especially one open to public visitation (e.g., amusement parks, casinos, shopping centers). Assisting security personnel in preventing incidents can include readily providing adequate and appropriate security and non-security related information to security personnel, whether the security personnel (e.g., security officer) is stationed in a security office or on patrol (i.e., in the field) at the facility.

In addition to storing identification information for individuals (e.g., past suspects) and information regarding past incidents (i.e., security issues) at the facility, a specific implementation can provide predictive information regarding potential security issues based on information gathered from various sources internal and external to the facility. Example sources for such information include public access databases, Internet resources that provide information regarding current and recent happenings in areas neighboring the facility, information regarding current and recent happenings within the facility, and information from similar facilities in other locations in the state, country, or world. The predictive information generated can assist security personnel in anticipating security issues before they happen, possibly helping in prevention of such issues.

### BRIEF DESCRIPTION OF THE DRAWINGS

FIG. 1 depicts an example of a security issue prevention system.

FIG. 2 illustrates data communication between components of an example system.

FIG. 3 depicts a flowchart of an example of a method of improving security at a facility.

FIG. 4 depicts a flowchart of an example of generating predictive information relating to a security issue.

FIG. 5 illustrates an association between individuals and incidents.

FIG. 6 is a screenshot illustrating an example of an input interface for a terminal engine interface.

FIG. 7 is a screenshot illustrating an example of an input interface for a terminal engine.

FIG. 8 is a screenshot illustrating an example of an input interface for a community engine.

FIG. 9 is a screenshot illustrating an example of links provided by a law data aggregation engine.

FIG. 10 is a diagram illustrating an example of a computing system with which aspects of the systems and methods described herein can be implemented.

### DETAILED DESCRIPTION

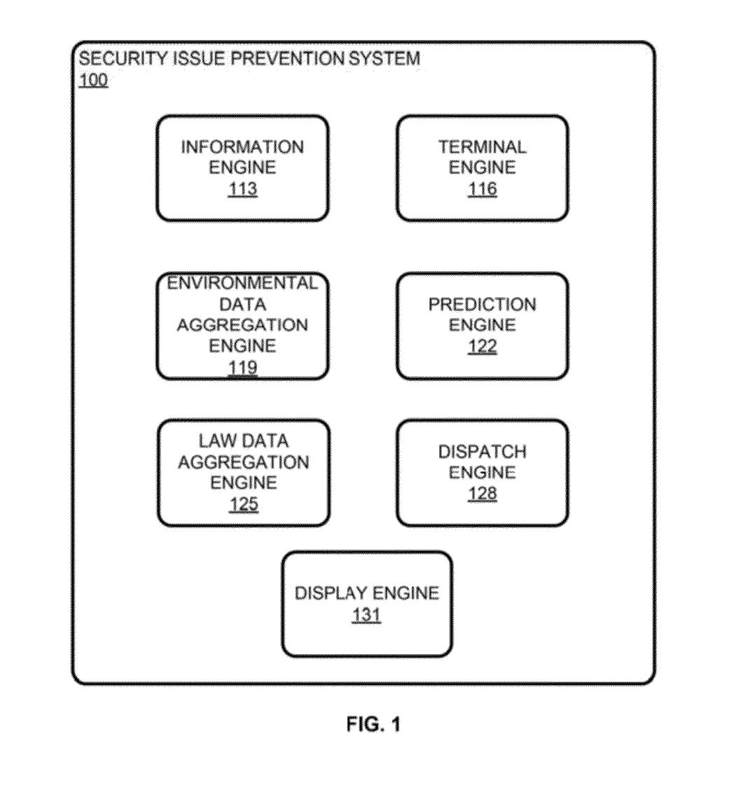

Techniques described in this paper are applicable to systems and methods for venting security issues at a facility. FIG. 1 depicts an example of a security issue prevention system. As shown in FIG. 1, the security issue prevention system 100 comprises an information engine 113, a terminal engine 116, an environmental data aggregation engine 119, a prediction engine 122, a law data aggregation engine 125, a dispatch engine 128, and a display engine 131.

As used in this paper, an engine includes a dedicated or shared processor and, typically, firmware or software modules that are executed by the processor. Depending upon implementation-specific or other considerations, an engine can be centralized or its functionality distributed. An engine includes special purpose hardware, firmware, or software embodied in a computer-readable medium for execution by the processor. As used in this paper, a computer-readable medium is intended to include all mediums that are statutory (e.g., in the United States, under 35 U.S.C. §101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The information engine 113 is configured to receive suspect information or incident information from a terminal engine, store such information in datastore (such a relational database or the like), and transmit such information to a terminal engine or another engine when requested to do so. As such, the information engine 113 can be characterized as comprising a suspect data aggregation engine for collecting data about suspects and an incident data aggregation engine for collecting data about an incident. Suspect information can include a suspect's name, a suspect's address, a picture of a suspect, an inventory of possessions found on a suspect, a picture or description of a suspect's possessions, or a suspect's physical characteristics (e.g., race, sex, hair type, hair color, eye color, height, weight, a tattoo, a marking, a piercing, a fingerprint, a eye scan, a DNA sample, or a voice scan). In order to collect some types of suspect information, the information engine 113 can be configured to receive information from external devices, such as, for example, biometrics devices (e.g., eye scanners, DNA sampling devices, fingerprint scanners), microphones, recorders, or cameras.

Suspect information can also include known or recently discovered aliases for a suspect, a suspect's unusual habits, a suspect's observed behaviorisms, and a suspect's association with other individuals who may also have suspect information stored in the information engine 113. For example, if an individual suspected of causing an incident at the facility is approached and questioned by security personnel, some embodiments allow security personnel to include in the suspect information the names of other individuals that were accompanying the individual at the time of questioning. Such embodiments are able to store these as associations such that they can later be retrieved or searched upon when an security officer is conducting a search regarding a suspect or their acquaintances.

In cases where the suspect is encountered while in or near a vehicle or where a suspect has travelled to the facility by way of a personal vehicle, suspect information can further include information regarding the vehicle, such as the make or mode of the vehicle, the license plate of the vehicle, an interior color or exterior color of the vehicle, a vehicle identification number of the vehicle, a picture of the vehicle, or registration information regarding the vehicle owner.

With regard to incidents, information regarding an incident can include a time of the incident, a date of the incident, a location of the incident, a type of incident (e.g., crime, casino scam, or offense of facility policy), a list of facility personnel involved in the incident (e.g., employees, or security personnel), a list of suspects involved in the incident, or a description of the incident. The incident information can be used to describe a crime or offense that took place at the facility, or can describe an encounter between security personnel and an individual (e.g., security personnel approach and question an individual at the facility based on suspicious activity or behavior). The incident information can further include a picture of the incident or a reason (e.g., probable cause) for security personnel to stop and question an individual at the facility.

As noted herein, the suspect information or incident information can be stored in a datastore of the information engine 113 as, e.g., objects of a relational database where, for example, each suspect can be represented by a unique database object and each incident can be represented by a unique database object. For instance, a suspect object the relational database can be used to store suspect information relating to a specific individual, and an incident object in the relational database can be used to store incident information relating to a specific incident. Additionally, each suspect and incident database object can have a unique object identifier that distinguishes it from other database objects of the same kind, and can be utilized to associate suspect objects and incident objects together.

For example, the suspect objects and incident objects in the relational database can be associated with one another in the database when a suspect is involved in particular incident or involved with another suspect, or where an incident is associated with another incident. As later discussed herein, this association between suspect and incident objects can occur either automatically based on information stored in the (suspect and incident) objects (e.g., two suspect objects contain the same or similar residential address), or based on associations entered by security personnel through a terminal engine. Upon request, the information engine 113 can provide requesting terminal engines (or other engines within the system 100) information from the suspect objects, the incident objects, and the associations therebetween.

The terminal engine 116 is configured to communicate with the information engine and transmit suspect information or incident information to the information engine 113, as well as receive suspect information or incident information requested from the information engine 113. Generally, the terminal engine 116 can be any type of computing device having network communications capability, whether it be through a wired connection (e.g., Ethernet, or modem) or through a wireless connection. Usually, the terminal engine 116 has an input interface, such as a keyboard or a touch screen, that allows security personnel to enter information into the terminal engine or request information from the information engine 113. Examples of terminals engines include, without limitation, desktop computers, mobile computers, smartphones, cellular phones with texting capabilities, and tablet devices. Where the terminal engine 116 is a portable device, such as a mobile computer, smartphone or cellular phone, security personnel can readily enter and retrieve information from the information engine 113 while patrolling the facility. For example, if security personnel deployed in the field want to retrieve information relating to a vehicle having a specific license plate, they can enter the license plate number into a portable terminal engine, which will transmit the entered information to the information engine 116 and, in response, receive from the information engine 116 information from suspect objects or incident objects related to the specified license plate.

In order to secure the system 100 from unauthorized individuals, and limit access to personal information of suspects to only certain authorized personnel, the system 100 can be configured to communicate with only terminal engines that have entered the appropriate username and password, and that have a network identifier (e.g., IP number) that is listed on an access list (e.g., IP white list). Other security measures can include token-based logins and user policies that allow a system administrator to limit the functions and features available to a user. Though not illustrated, the system 100 can further comprise an audit engine configured to monitor and record information regarding user login and activity on the system 100; such information can allow administrators ors of the system 100 to audit client usage and investigate any claims of unauthorized activity on the system 100.

The environmental data aggregation engine 119 is configured to collect and store environmental information regarding an environment external to the facility or an environment internal to the facility, the external environment being at or around the facility. Information relating to the environment external to the facility can include, for example, a traffic report for roadways at or around the facility (e.g., road closers around the facility, traffic jams, traffic accidents, road construction), a transportation schedule (e.g., bus or train at the local station or flight delays at local airport), a crime report for areas at or around the facility (e.g., via local law enforcement), a weather forecast for areas at or around the facility (e.g., 24-hour weather forecast), a local events calendar for community in which the facility resides (e.g., festivals, parades, fairs, conventions, and similar events scheduled for the local city or county), or a report on unusual activity observed in areas at or around the facility (e.g., reports from local community watch programs). Information relating to the environment internal to the facility can include, for example, occupancy of the facility (e.g., current occupancy of casino gaming floor), an events calendar for the facility (e.g., concerts, conventions, or events scheduled at the facility), a room temperature in the facility (e.g., room temperature at or around the casino gaming area), or operational information regarding the facility (e.g., maintenance issues at the facility). Such environment information can be viewed by security office personnel via the display engine 131 or be utilized by the prediction engine 122 to generate information that forecasts a safety or security issue at the facility (e.g., bus delays at local bus depot could result in an increase in visitors to facility) and, possibly, its likelihood or occurrence.

The law data aggregation engine 125 is configured to collect a law or a regulation applicable to facility based on a legal jurisdiction or area in which the facility resides. For example, if the facility utilizing the system 100 resides in Fontana, Calif., which resides in San Bernardino County, the law data aggregation engine 125 can collect law and regulations from the California Penal Code and from ordinances for the city of Fontana. The law data aggregation engine 125 can be further configured to collect links to, or data from, Internet resources that provide public or limited access to local, state, or federal government data. For instance, the law data aggregation engine 125 can collect links to local, state, and government websites that provide access to such information sources as county public records, lists of local sex offenders, corner's office death releases, fire incidents, inmate information, law enforcement press releases, a law enforcement live calls, most-wanted lists, law enforcement reports, or law enforcement crime call logs, or law enforcement crime call maps. The system 100 can provide security personnel access to such information through the terminal engine 116 or through the display engine 131. Through the terminal engine 116 the information collected by the law data aggregation engine 125 becomes readily available to security personnel regardless of whether they are stationed in a security office or on patrol around the facility (i.e., in the field). As later described herein, through the display engine 131, the information collected by the law data aggregation engine 125 becomes readily visible to security personnel in the security office.

The prediction engine 122 is configured to recognize a pattern in the environmental information, the suspect information, or the incident information, and generate predictive information that forecasts a safety or security issue based on the pattern and, possibly, the likelihood of its occurrence. Depending on the embodiment, the prediction engine 112 can analyze the environmental information, the suspect information, or the incident information stored in the information engine 113 (both past and present information) and, using known predictive analysis techniques (such as modeling, data mining and other statistical methodologies), identify patterns within or between any of the information. Patterns can be recognized based on many aspects contained in the information including, for example, the time of the year, the type of incidents, the type of visitors to the facility, the conditions outside the facility, the conditions side the facility, and local events.

Then, based on the pattern, the predictive engine 122 generates predictive information, which can be utilized by the other engines in the system 100. For example, the predictive engine 122 can recognize a historical pattern where local road highway closures results in increased visitation to the facility (e.g., casino) by truck drivers who are prevented from continuing with their journey, and where increased visitation by truck drivers usually leads to more fights within the facility. In this particular example, the predictive engine 122 would generate predictive information that forecasts, as a safety and security issue, an increased number of truckers in the facility and the increased likelihood of a fight occurring in the facility whenever there are local highway closures. With predictive information, information can be appropriately displayed in accordance with heightened priorities.

In another example, the predictive engine 122 can identify a pattern where every Halloween, the facility (e.g., amusement park) experiences increased visitation by teenagers 18 and younger, and that there is an increase in assaults at the facility. In this example, the predictive engine 122 would generate predictive information that forecasts, as a safety and security issue, an increased number of teenagers at the facility and the increased likelihood of assaults at the facility around the time of Halloween.

The dispatch engine 128 is configured to dispatch and monitor personnel involved in preventing security issues at the facility and, based on the dispatching and monitoring, maintain dispatch information regarding the personnel. For example, the dispatch engine 128 can dispatch security personnel to a specific area of the facility based on recent security issues in the area, can monitor the status and whereabouts of security personnel on patrol in designated areas of the facility, and/or adjust work schedules to take into account predicted times of heightened risk. In a specific implementation, the dispatch engine 128 can provide the dispatch information it maintains to other engines within the system 100 for display and, possibly, analysis of facility security.

The display engine 131 is configured to simultaneously display information from one or more engines present in the system 100. Through use of the display engine 131, security personnel can view information from multiple engines quickly, easily, and simultaneously. For example, the display engine 131 can be configured to display information from the information engine 113, the environmental data aggregation engine 119, the prediction engine 122, the law data aggregation engine 125, the dispatch engine 128, or any combination thereof. Depending on implementation- or configuration-specific considerations, the display engine can comprise two or more monitors that display information from each engine simultaneously. For instance, the display engine 131 can comprise one monitor for each type of information being displayed (i.e., one monitor for the information engine 113, one monitor for the prediction engine 122, one monitor for the law data aggregation engine 125, one monitor for the dispatch engine 128). So, while one display receives dispatch information regarding security personnel from the dispatch engine 128, a second display receives suspect information and incident information from the information engine; a third display receives laws, regulations; and links to publicly-accessible government databases from the law data aggregation engine 125, and a fourth display receives prediction information forecasting potential security issues at the facility from the prediction engine 122. This can facilitate, for example, efficient observation of relevant data in real-time as it becomes available, without requiring opening a window for the specific purpose.

In some embodiments, the display engine 131 can be further customized to display information according to username and password provided by security personnel. For instance, certain security personnel can have limited access to the suspect information stored in the information engine 113 (e.g., to prevent inappropriate use of suspect personal information) while having unlimited access to information from the other engines of the system 100.

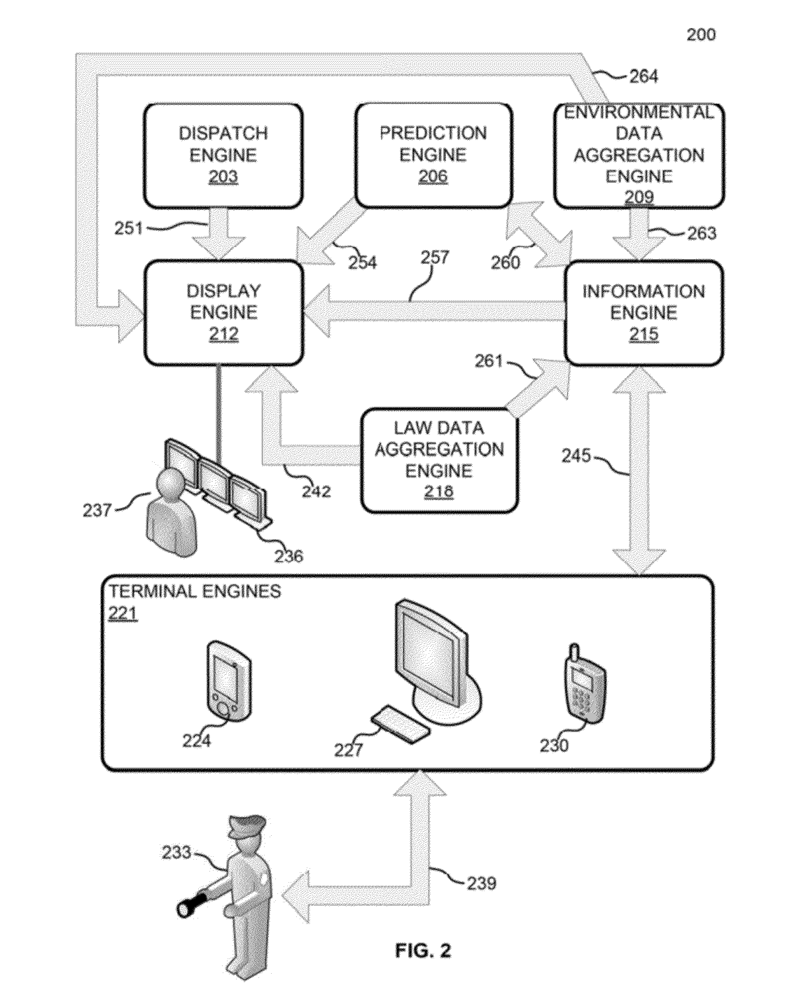

FIG. 2 is a diagram illustrating data communication between components of an example system 200. The system 200 comprises: a dispatch engine 203, a prediction engine 206, and an environmental data aggregation engine 209, a display engine 212, an information engine 215, a law data aggregation engine 218, and terminal engines 221. Also shown in FIG. 2, a member 233 of a facility's security force (i.e., a security officer) on patrol, and a security officer 237 located in a security office that is monitoring information provided by various engines through a bank of displays 236 (e.g., computer displays).

Beginning at the terminal engines 221, a security officer 233 on patrol can access the system 200 through a terminal engine in the form of a smart phone 224, a remote terminal 227, a regular cellular phone having text messaging capabilities 230, or a tablet device (not shown). Depending on the circumstances, the security officer 233 may be accessing 239 the terminal engine (221) for one of a number of reasons including, for example, to enter and store into the information engine 215 suspect information or incident information obtained during their patrol. Under other circumstances, the security officer 233 may use a terminal engine (221) to search for an individual's identity (e.g., before accosting them) by submitting search parameters relating to the individual to the information engine 215 and waiting for a response from the information engine 215 to the terminal engine (221). In addition to suspect information and incident information, the information engine 215 can further operate to relaying information from other engines, such as the environment data aggregation engine 209, prediction engine 206, or law data aggregation engine 218.

As shown, the information engine 215 functions as a central storage component for the system 200, capable of sending and receiving suspect information or incident information to and from the terminal engines 221 (via 245), capable of sending suspect information or incident information (and possibly other stored information) to the prediction engine 206, and capable of receiving prediction information from the prediction engine 206 (via 260). The information engine 215 can also provide suspect information or incident information to the display engine 212. The information engine 215 receives environmental information from the environmental data aggregation engine 209 and receives laws, rules, and links from the law data aggregation engine 218.

As described herein, the display engine 212 functions to display information from various engines to a bank of displays 236 being monitored by a security officer 237. The display engine 212 collects dispatch information from the dispatch engine 203, prediction information from the prediction engine 206, and laws, regulations, and links from the law data aggregation engine 218. From the dispatch information, the security officer 237 can determine the present status of security personnel on duty and/or patrolling the facility. Using the prediction information, the security officer 237 can review forecasts on security issues for the facility. The data from the law data aggregation engine 218 allows security officer 237 to quickly reference to local, state and federal laws, regulations, and government data applicable to the jurisdiction or area in which the facility resides. As such, in some embodiments, the data collected law data aggregation engine 218 can be customized based on the facility it is serving.

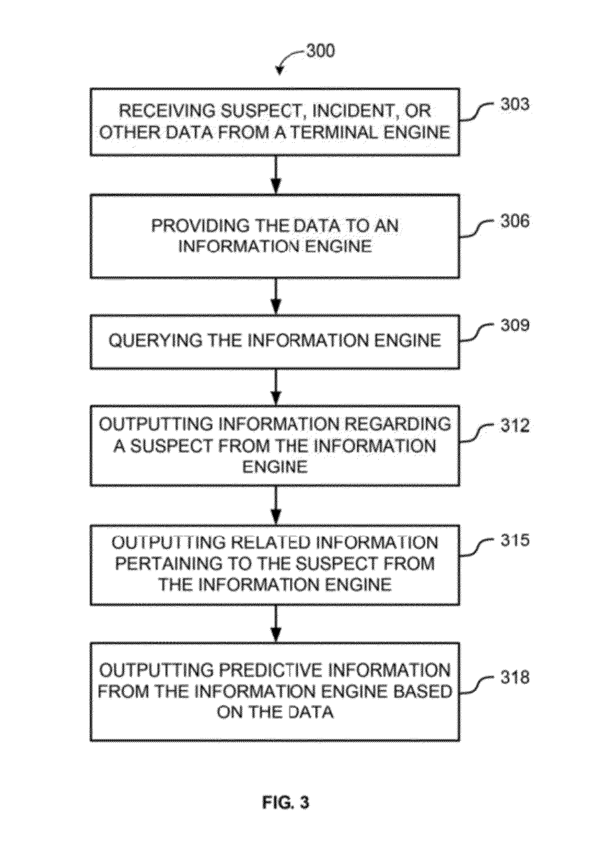

FIG. 3 depicts a flow chart 300 of an example of a method of improving security at a facility. Specifically, the flowchart 300 illustrates an example method for providing security officers information through a terminal engine. In the example of FIG. 3, the flowchart 300 begins at module 303 with receiving suspect, incident, or other data from a terminal engine. For example, the information can be entered into the terminal engine by a security officer, either on patrol or in a security office.

In the example of FIG. 3, the flowchart 300 continues to module 306 with providing the data to an information engine. For example, the data can be transmitted from the terminal engine to the information engine using a private network of the applicable facility. Alternatively, the information can be transmitted through some other network, such as a cellular network, the Internet, or some other network.

In the example of FIG. 3, the flowchart 300 continues to module 309 where the information engine is queried. Typically, the query is by a security officer seeking information from the information engine. For example, the security officer may be attempting to identify a suspect at the facility and queries the information system with search parameters in order to determine that identity (e.g., based on physical description, or the vehicle arrived in). Automatic queries can also be initiated based upon environmental or other parameters detected by the security system. For example, if information is received from a terminal engine related to a repeat-offender, it may be desirable to automatically generate a query and provide the information to a relevant display or terminal engine.

In the example of FIG. 3, the flowchart 300 continues to module 312 with outputting information regarding a suspect from the information engine. The output may or may not be in response to a query from a security officer. As was previously mentioned, a query can be automatic based upon environmental parameters, in which case the information regarding a suspect can be output to a relevant display or terminal engine.

In the example of FIG. 3, the flowchart 300 continues to module 315 with outputting related information pertaining to the suspect from the information engine. In some instances, a response may be a listing of several suspects or several incidents that match the search parameters provided by the security officer. For example, the identification of a suspect may enable identification of known members of a group of offenders who operate in teams. In such cases, a security officer can review the resulting list on a display and terminal engine and, possibly, request further information from the information engine when and where appropriate.

In the example of FIG. 3, the flowchart 300 continues to module 318 with outputting predictive information from the information engine based on the data. In a specific implementation, one or more terminal engines can receive predictive information based upon data available at the information engine. Such predictive information may or may not be periodically sent to the terminal engine regardless of whether a query is submitted to the information engine. By sending the predictive information periodically, security officers can be regularly alerted and warned of current, potential security issues at and around the facility.

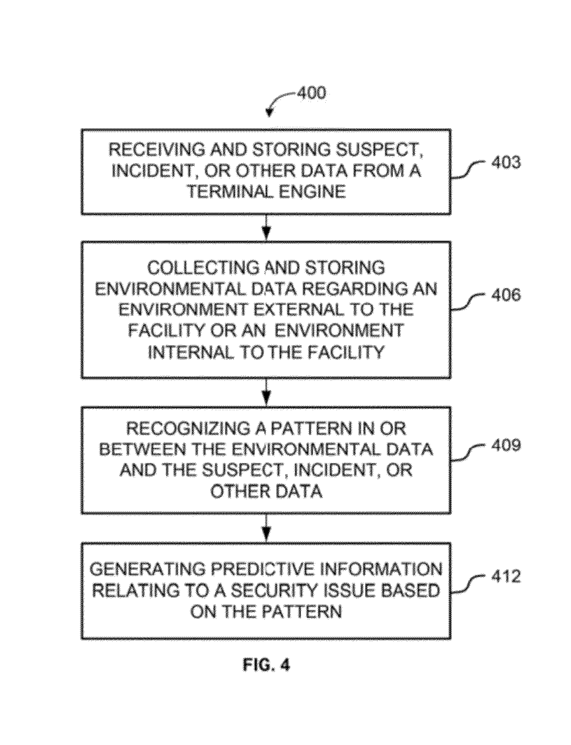

FIG. 4 depicts a flowchart 400 of an example of generating predictive information relating to a security issue. In the example of FIG. 4, the flowchart 400 begins at module 403, where suspect, incident, or other data is received from a terminal engine and stored. In a specific implementation, the component receiving and storing the data includes an information engine.

In the example of FIG. 4, the flowchart 400 continues to module 406, collects and stores environmental data relating to an environment external (e.g., city, or county) to the facility or an environment internal to the facility (e.g., specific rooms or areas of the facility). In a specific implementation, an information engine stores the collected environmental data. In a specific implementation, the environmental data can be collected from multiple sources, such as resources available over the Internet (e.g., weather websites, local news pages, or state highway services page) and sensors stationed throughout the facility (e.g., temperature sensor, infrared sensors, motion sensors, or cameras).

In the example of FIG. 4, the flowchart 400 continues to module 409 with recognizing one or more patterns in or between the environmental data and the suspect, incident, or other data collected. The patterns can be recognized using applicable known or convenient predictive analysis techniques, including data mining and other statistical analysis algorithms.

In the example of FIG. 4, the flowchart 400 continues to module 412 with generating predictive information relating to a security issue based on the pattern. Such predictive information can assist security personnel prepare for such security issues and be mindful of such security issues.

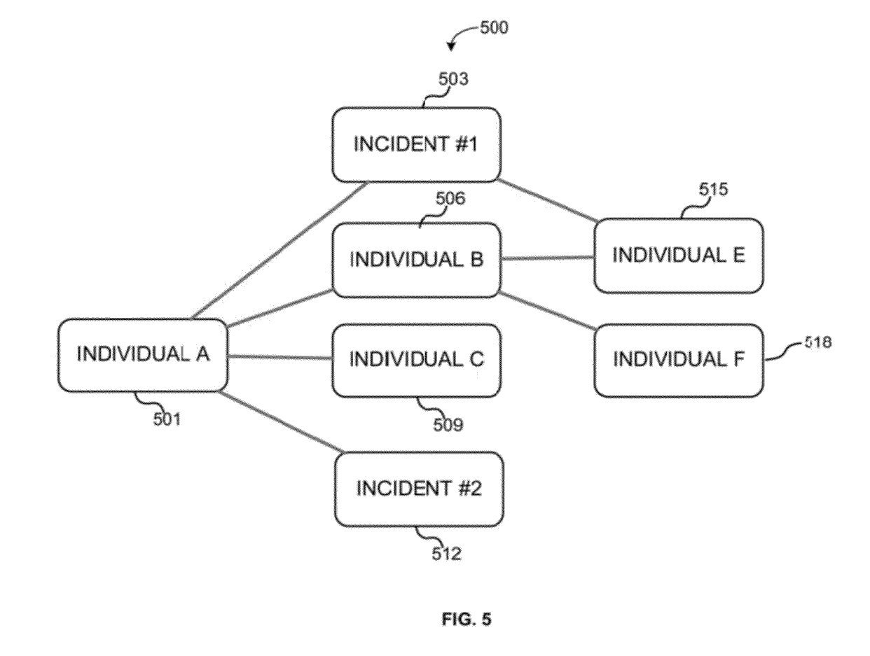

FIG. 5 illustrates an association between individuals and incidents. An information engine can store information regarding associations between suspects, between incidents, and between suspects and incidents. Once stored, this information can be provided to a security officer when a suspect's or incident's information is requested. For example, with reference to FIG. 5, if a security officer were to retrieve information regarding individual A (501), the security officer can be provided with association information (e.g., a link) relating to incident #1 (503), individual B (506), individual C (509), and incident #2 (512). Subsequently, if the security officer inquired further regarding incident #1 he or she would be provided with association information relating to individual E (515) and individual A (501), both of which are associated with incident #1 (503). Likewise, if security officer inquired further with respect to individual B (506), he or she would be provided with association information relating to individual E (515), individual F (518), and individual A (501), all of which are associated with individual B (506). Each of the individuals shown could be represented by a suspect database object, and each of the incidents shown could be represented by an incident database object.

A pattern matching algorithm may be able to identify suspects who are around at the same time as an incident (e.g., as a known witness or bystander). Advantageously, it is possible to form low-level associations between individuals and/or incidents that are brought to the attention of security personnel only after matching an incident or suspect twice. For example, if individual E (515) is a witness of incident #1 (503) and is around at the time of incident #2 (512) as detected by a security camera, the fact that individual A (510) is indirectly linked to individual E (515) can be analyzed by a prediction engine to determine a relevant association to incident #2 (512) or at least a security officer could be notified regarding a potential low-level association. This can help identify suspects that work in teams.

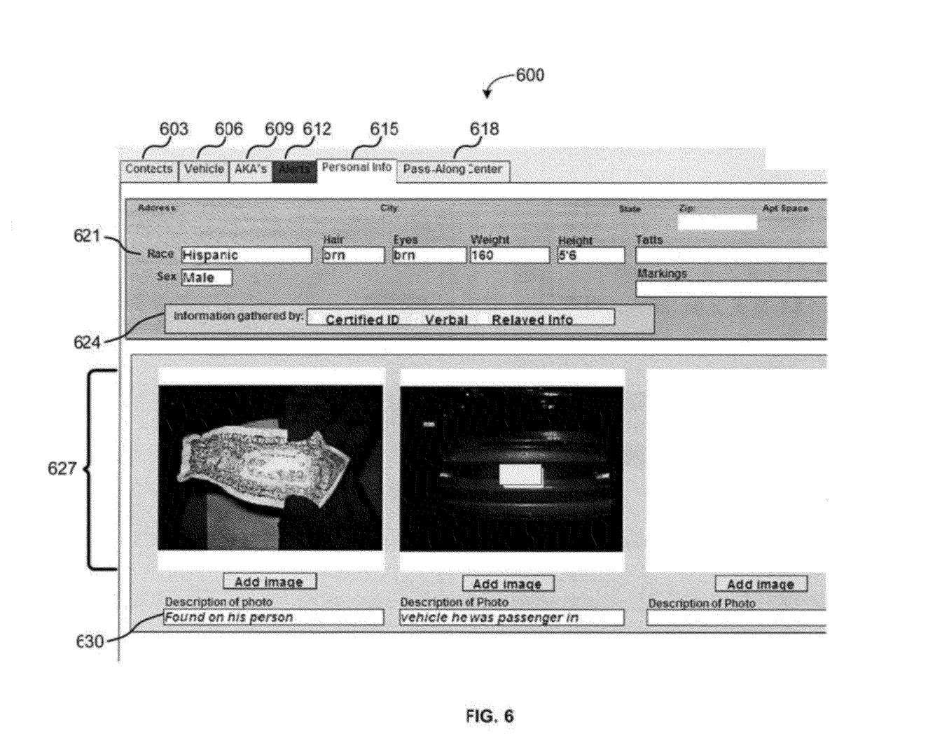

FIG. 6 is a screenshot illustrating an example of an input interface 600 for a terminal engine interface. In particular, screenshot depicts an interface 600 for security officers to access (e.g., review or edit) suspect information or incident information through a system in accordance with an embodiment. A security officer using interface 600 can access a suspect's contact information (603), a vehicle information relating to a suspect (606), a suspect's aliases (609), alert's regarding a suspect (612), and personal information relating to a suspect (615). Also shown is access to a community section (618) through which a security officer can access a community engine configured to share information with other facilities that are member of the system community (e.g., other casinos in the state or county).

Continuing with reference to FIG. 6, interface 600 is shown as currently being on a suspect's personal information section (615). Under this section, a security officer can review or edit a suspect's information 621 (e.g., residential address, race, hair color, eye color, weight, height, tattoos, markings, sex), review or designate the method 621 by which the personal information was acquired (e.g., verified by identification, through verbal communication, or information relayed from another individual or security officer), review and upload pictures 627 relating to a suspect (e.g., vehicle they were encountered in, objects they had in their possession), and review or edit pictures descriptions 630 for the pictures relating to a suspect.

Although not shown, interface 600 can also allow access to information relating to associations a suspect may have with other suspects or incidents, an inventory of possessions found on a suspect during their encounter with security personnel, a history of encounters with a suspect at the facility, and a notes sections to record other miscellaneous information regarding a suspect.

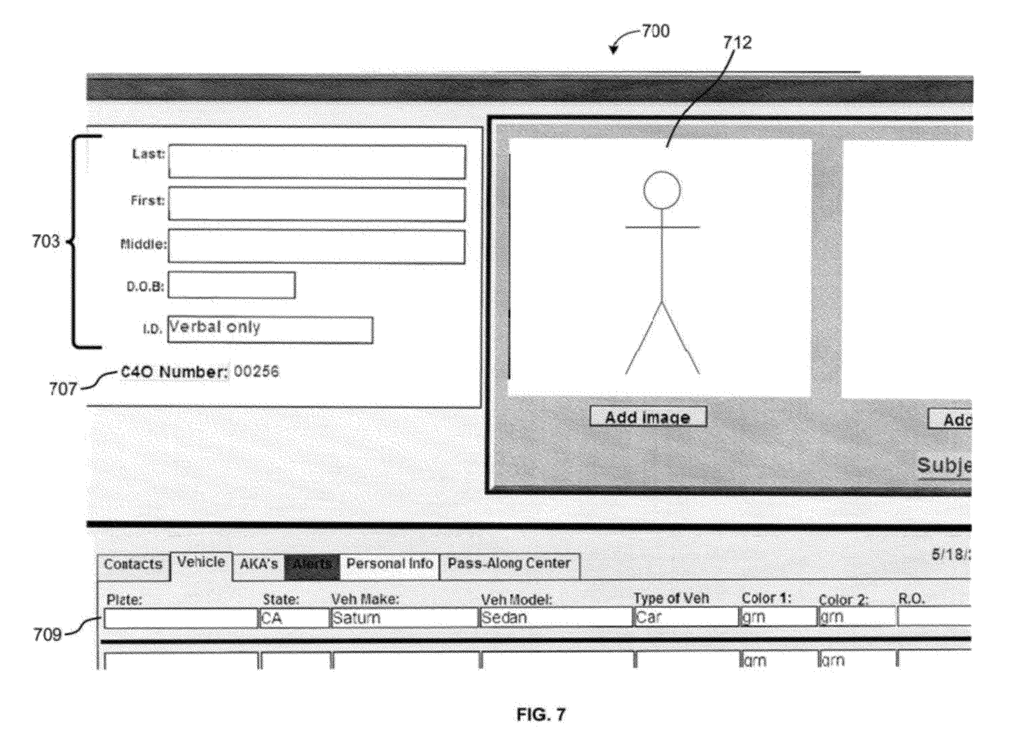

FIG. 7 is a screenshot illustrating an example of an input interface for a terminal engine. In particular, screenshot depicts interface 700 through which security officers can access (e.g., review or edit) more suspect information or incident information through a system in accordance with an embodiment. Specifically, as shown, a security office using interface 700 can access a suspect's name, date of birth, and form of identification (703), view a suspects identification number 707 in the system, and review and upload pictures of a suspect. Interface also allows a security officer to access information 709 for vehicles associated with a suspect. As shown, such information includes the license plate state and number of a vehicle, a vehicle's make and model, the type of vehicle, the interior and exterior colors of a vehicle, and registered owner information for a vehicle.

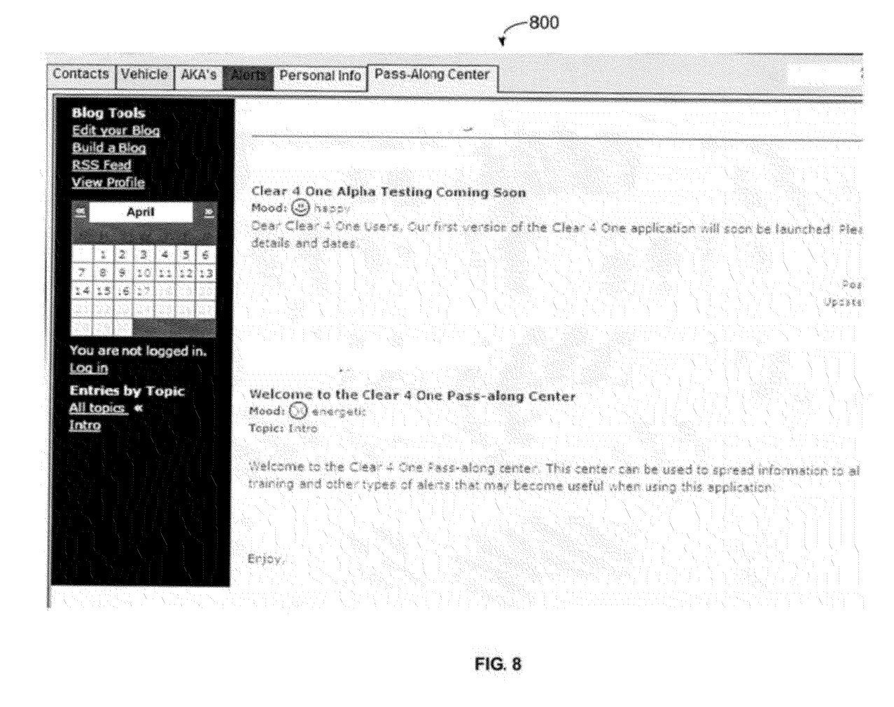

FIG. 8 is a screenshot illustrating an example of an input interface for a community engine. As noted herein, the community engine is configured to allow sharing of information between two or more like or different facilities. Depending on the embodiment, through the community engine, security personnel for a facility can share information either manually or automatically with other facilities. The shared information can include confidential information regarding suspects or incidents, or more generalized information regarding the same. For some embodiments, the community engine serves as a information conduit through which facilities country-wide or state-wide can collaborate security efforts through suspect and incident information.

In FIG. 8, community engine interface 800 allows for security personnel at one facility to post information regarding suspects, incidents, and other security issues to the entire community. In some embodiments, the community engine is implemented using electronic message posting system (e.g., an electronic bulletin board, an Internet forum, social media site, or a blog system). Although not shown, the community engine can further allow security personnel from facilities to add commentary to messages posted or, alternatively, directly reply to posters through a private messaging system.

In a specific implementation, in place having a community engine, the system can be configured for community access, with each facility having its own set of login information to access the system. The sets login information can be configured such that access to certain specified information remains accessible by security personnel of the facility that originally entered the information (e.g., security personnel of facility B can have limited to no access to suspect information entered by security personnel of facility A). In a specific implementation, the system can further maintain separate datastores (e.g., relational databases) for each community or, alternatively, a shared communal datastore for information stored in the system.

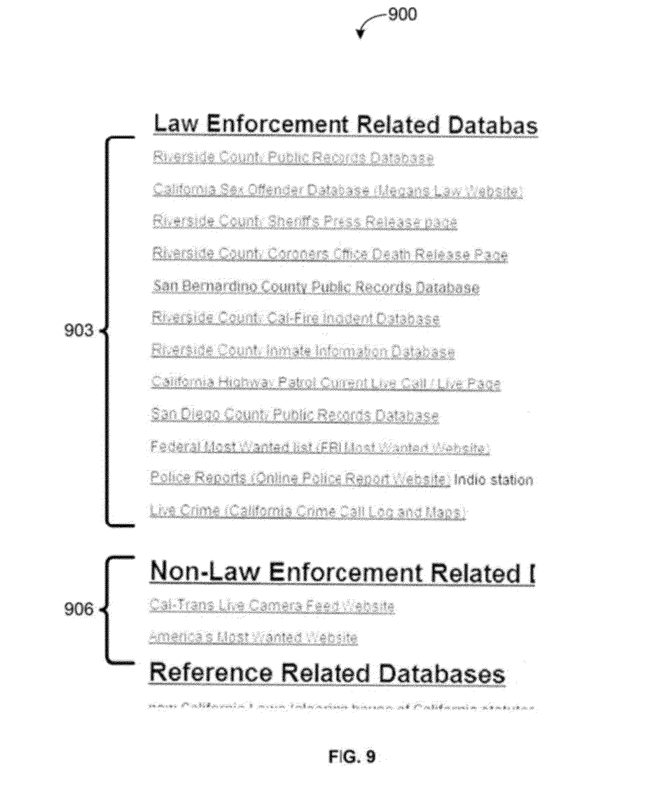

FIG. 9 is a screenshot illustrating an example of links provided by a law data aggregation engine. Specifically, interface 900 provides access to website links to public and limited access websites that are made available by local, state, and federal government agencies and that are applicable to the area or jurisdiction in which the facility resides. In the case of FIG. 9, the particular facility using interface 900 resides in California and in close proximity to Riverside County, San Bernardino County, and San Diego County. As such, interface 900 provides links 903 to numerous city, county, and state websites related to those areas of California, including a county public records database, a state sex offender database, a county coroner's office death release page, a state fire incidents database, a county inmate information database, numerous law enforcement live call and crime log pages, and a federal most wanted list. Also included in interface 900 are links 906 to state traffic cameras, and other non-law enforcement related websites containing information useful to the facility's security personnel.

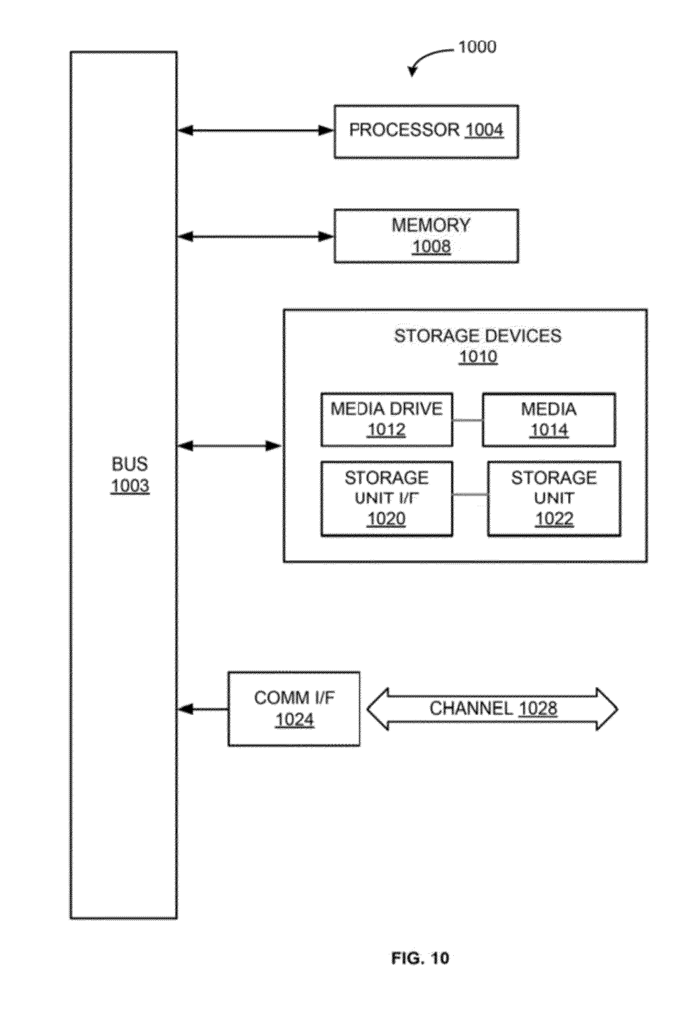

Referring now to FIG. 10, computing system 1000 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose general-purpose computing devices as may be desirable or appropriate for a given application or environment. Computing system 1000 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 1000 might include, for example, one or more processors, controllers, control engines, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing system 1000 or to communicate externally.

Computing system 1000 might also include one or more memory components, simply referred to herein as main memory 1008. For example, preferably random access memory (RAM) or other dynamic memory, might be used for storing information and instructions to be executed by processor 1004. Main memory 1008 might also be used for storing temporary variables or other intermediate information during execution of instructions to be executed by processor 1004. Computing system 1000 might likewise include a read only memory (“ROM”) or other static storage device coupled to bus 1002 for storing static information and instructions for processor 1004.

The computing system 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a floppy disk drive, a magnetic tape drive, an optical disk drive, a CD or DVD drive (R or RW), or other removable or fixed media drive might be provided. Accordingly, storage media 1014 might include, for example, a hard disk, a floppy disk, magnetic tape, cartridge, optical disk, a CD or DVD, or other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing system 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component) and memory slot, a PCMCIA slot and card, and other fixed or removable storage units 1022 and interfaces 1020 that allow software and data to be transferred from the storage unit 1022 to computing system 1000.

Computing system 1000 might also include a communications interface 1024. Communications interface 1024 might be used to allow software and data to be transferred between computing system 1000 and external devices. Examples of communications interface 1024 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1024 might typically be carried on signals, which can be electronic, electromagnetic (which includes optical) or other signals capable of being exchanged by a given communications interface 1024. These signals might be provided to communications interface 1024 via a channel 1028. This channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 1000 to perform features or functions of the present invention as discussed herein.

The various diagrams may depict an example architectural or other configuration for the invention, which is done to aid in understanding the features and functionality that can be included in the invention. The invention is not necessarily restricted to the illustrated example architectures or configurations, and the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent engine names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should also be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a law data aggregation engine;
a environmental data aggregation engine;
a suspect aggregation engine;
an incident aggregation engine;
a prediction engine;
an information engine coupled to the law data aggregation engine, the environmental data aggregation engine, the suspect aggregation engine, the incident aggregation engine, and the prediction engine;
a display engine coupled to the information engine;
wherein, in operation:
the law data aggregation engine collects a law or a regulation applicable to a facility based on a legal jurisdiction of the facility or area in which the facility exists;
the environmental data aggregation engine collects environmental data regarding an environment external to a facility or an environment internal to the facility, the external environment being at or around the facility;
the suspect aggregation engine receives suspect data from a terminal engine;
the incident aggregation engine receives incident data from a terminal engine;
the prediction engine recognizes a pattern in a subset of the environmental data, the suspect data, and the incident data, and generates predictive information that forecasts a safety or security issue based on the pattern;
the display engine displays at least a portion of the law or regulation; the subset of the environmental data, the suspect data, and the incident data; and the predictive information associated with the safety or security issue.

2. The system of claim 1, the system further comprising a dispatch engine configured to dispatch and monitor personnel involved in preventing or managing security issues at the facility and maintain dispatch information regarding the personnel.

3. The system of claim 2, wherein the display engine is configured to simultaneously display dispatch information from the dispatch engine.

4. The system of claim 1, wherein law data aggregation engine collecting the law or the regulation involves collecting and displaying a link to an Internet resource that contains the law or the regulation.

5. The system of claim 1, the law data aggregation engine further configured to collect data from or a link to an Internet resource that provides public or limited access to government data, wherein the Internet resource comprises a county public records database, a sex offender database, a corner's office death release page, a fire incident database, an inmate information database, a law enforcement press release page, a law enforcement live call page, a law enforcement most-wanted page, an law enforcement report page, or a law enforcement crime call log, or a law enforcement crime call map.

6. The system of claim 1, wherein the environmental data regarding the external environment includes a traffic report for roadways at or around the facility, a transportation schedule, a crime report for an area at or around the facility, a weather forecast for an area at or around the facility, a local events calendar for community in which the facility resides, or a report on unusual activity observed in an area at or around the facility.

7. The system of claim 1, wherein the environmental data regarding the internal environment includes occupancy of the facility, an events calendar for the facility, a room temperature in the facility, or operational information regarding the facility.

8. The system of claim 1, wherein the terminal engine is further configured such that personnel involved in preventing security issues at the facility can use the terminal engine to input and display suspect information or incident information while the personnel are deployed in the field.

9. The system of claim 1, wherein the suspect information includes race, sex, hair type, hair color, eye color, height, weight, a tattoo, a marking, a piercing, a fingerprint, a eye scan, a DNA sample, or a voice scan.

10. The system of claim 1, wherein the suspect information includes a make or model of a suspect's vehicle, license plate information of the suspect's vehicle, an interior color of the suspect's vehicle, an exterior color of the suspect's vehicle, a vehicle identification number of the suspect's vehicle, a picture of the suspect's vehicle, registration information regarding the suspect's vehicle, a suspect's drivers license information, a suspect's name, a suspect's address, a suspect's alias, a picture of a suspect, an inventory of possessions on a suspect, or a picture or a description of a suspect's possession.

11. The system of claim 1, wherein incident information includes a time of an incident, a date of the incident, a location of the incident, a list of facility personnel involved in the incident, a description of the incident, or a picture of the incident.

12. The system of claim 1, wherein incident information includes an unusual activity observed in an area at or around the facility by personnel involved in preventing security issues at the facility, or a crime that has occurred in an area at or around the facility.

13. The system of claim 1, wherein the environmental data aggregation engine is further configured to store notes related to the law or the regulation entered by personnel involved in preventing security issues at the facility.

14. The system of claim 1, wherein the prediction engine is further configured to generate an alert or warning, based on the predictive information, for personnel involved in preventing security issues at the facility.

15. The system of claim 1, further comprising a community communication engine configured to share suspect information or incident information from the information engine with another facility, and to share suspect information or incident information from another facility with the information engine.

16. The system of claim 1, wherein the terminal engine is further configured such that personnel involved in preventing security issues at the facility can use the terminal engine to associate information regarding first suspect stored in the information system with information regarding a second suspect stored in the information system.

17. The system of claim 1, wherein the prediction engine is further configured to associate information regarding first suspect stored in the information system with information regarding a second suspect stored in the information system based on the environmental information, the suspect information, or the incident information.

18. The system of claim 1, wherein the predictive information includes types of incidents likely to occur based on current and past environmental information, suspect information, and incident information; or likelihood of a crime or safety issue occurring based on current and past environmental information, suspect information, and incident information.

19. A method comprising:
receiving suspect data and incident data from a terminal engine;
providing the data to an information engine;
querying the information engine to identify a suspect based on the suspect information or incident information transmitted;
outputting information regarding a suspect form the information engine.

20. The method of claim 19, further comprising outputting related information regarding a suspect from the information engine, wherein the related information comprises an association to another suspect, a known acquaintance of the suspect, an alert or warning regarding the suspect, vehicle information relating to the suspect, or a history of incidents involving the suspect.

21. The method of claim 19, further comprising outputting predictive information from the information engine based on the data, wherein the predictive information includes types of incidents likely to occur based on the suspect information or the incident information.

22. The method of claim 19, further comprising outputting predictive information from the information engine based on the data, wherein the predictive information includes likelihood of a crime or safety issue occurring based on the suspect information or the incident information.

23. A method comprising:
collecting environmental data regarding an environment external to a facility or an environment internal to the facility, the external environment being at or around the facility;
receiving suspect data and incident data from a terminal engine;
recognizing a pattern in the environmental data, the suspect data, and the incident data;
generating predictive information relating to a security issue based on the pattern using predictive analysis of the current and past environmental data, suspect data, and incident data to detect a pattern that forecasts the security issue at the facility.
